(19) United States
(12) Patent Application Publication
(10) Pub. No.: US 2015/0316956 A1
(43) Pub. Date: Nov. 5, 2015

(54) TOUCH DEVICE

(71) Applicants: TPK Touch Solutions (Xiamen) Inc., Xiamen (CN); Optera Technology (Xiamen) Co., Ltd., Xiamen (CN)

(72) Inventors: Jing Yu, Xiamen (CN); Tsung-Ke Chiu, Tainan (TW); Yan Lin, Xiamen (CN); Shaoyi Sun, Quanzhou (CN); Shixing Song, Xiamen (CN); Chia-Ho Chen, Taoyuan (TW); Zhen Xu, Fuzhou (CN)

(21) Appl. No.: 14/702,760

(22) Filed: May 4, 2015

(30) Foreign Application Priority Data
May 4, 2014 (CN) 201410183895.7

(51) Int. Cl. G06F 1/16; G06F 3/041

(52) U.S. Cl. CPC G06F 1/16; G06F 3/041

(57) ABSTRACT

The present disclosure provides a touch device. The touch device comprises a sensor electrode layer, a conductive jumper and a dielectric layer. The sensor electrode layer includes conductive sensors. The conductive jumper is configured to electrically connect the conductive sensors. Moreover, the dielectric layer has a patterned surface, which physically contacts the conductive jumper and embeds therein a portion of the conductive jumper.

This application claims priority of the People's Republic of China Patent Application No. CN201410183895.7, filed on May 4, 2014, the entirety of which is incorporated by reference herein.

### BACKGROUND OF THE INVENTION

1. Field of the Invention

The present disclosure relates to touch-sensitive technology and, more particularly, to a touch device.

2. Description of the Related Art

Touch panels or touch screens have become more and more popular in electronic devices including, in particular, portable or hand-held devices such as personal digital assistants (PDAs) and mobile phones. In some existing touch panels, there is an island-like insulating layer in the sensor electrode structure, and a conductive layer is formed on the island-like insulating layer to provide electrical connection for sensors in the sensor electrode structure. In the manufacturing process, the conductive layer is required to jump over the island-like insulating layer, resulting in a locally raised portion on the island-like insulating layer. Nevertheless, the island-like insulating layer has a certain thickness and the conductive layer, as compared to the island-like insulating layer, is relatively thin. Consequently, among other deficiencies, the raised, relatively thin portion of the conductive layer on the island-like insulating layer is vulnerable to scratching, which may incur undesirably large resistance or even open circuit, and may hence damage the touch panel.

### SUMMARY OF THE INVENTION

The present disclosure provides a touch device to overcome or alleviate at least the above-mentioned issues. In at least one embodiment according to the present disclosure, the touch device includes a dielectric layer having a patterned surface. The patterned surface physically contacts a conductive jumper and embeds therein a portion of the conductive jumper. As a result, the embedded portion of the conductive jumper on the dielectric layer is less likely to be damaged by scratch. Even if an upper surface of the conductive jumper is incidentally scratched during a manufacturing process, the embedded portion of the conductive jumper can be kept unharmed and provide the desired connection function. Accordingly, the potential risks that touch devices are damaged due to a scratch across the surface of the conductive jumper, which may result in undesirably large resistance or open circuit, are reduced.

The foregoing has outlined rather broadly the features and technical advantages disclosure in order that the detailed description that follows may be better understood. Additional features and advantages of the embodiments will be described hereinafter, and form the subject of the claims. It should be appreciated by persons having ordinary skill in the art that the conception and specific embodiments disclosed may be readily utilized as a basis for modifying or designing other structures or processes for carrying out the same purposes disclosure. It should also be realized by persons having ordinary skill in the art that such equivalent constructions do not depart from the spirit and scope of the disclosure as set forth in the appended claims.

### BRIEF DESCRIPTION OF THE DRAWINGS

Embodiments, or examples, of the disclosure illustrated in the drawings are now described using specific languages. It will nevertheless be understood that no limitation of the scope of the disclosure is thereby intended. Any alterations and modifications in the described embodiments, and any further applications of principles described in this document are contemplated as would normally occur to persons having ordinary skill in the art to which the disclosure relates. Reference numerals may be repeated throughout the embodiments, but this does not necessarily require that feature(s) of one embodiment apply to another embodiment, even if they share the same reference number.

It will be understood that when an element is referred to as being “connected to” or “coupled to” another element, it may be directly connected to or coupled to the other element, or intervening elements may be present.

The objectives and advantages are illustrated with the following description and upon reference to the accompanying drawings, in which:

FIG. 1A is a schematic top view of a touch device in accordance with some embodiments.

FIG. 1B is a cross-sectional view of the touch device illustrated in FIG. 1A, taken along an AA′ direction, in accordance with some embodiments.

FIG. 2A is a schematic top view of a touch device in accordance with some embodiments.

FIG. 2B is a cross-sectional view of the touch device illustrated in FIG. 2A, taken along a BB′ direction, in accordance with some embodiments.

FIG. 3A is a schematic top view of a touch device in accordance with some embodiments.

FIG. 3B is a cross-sectional view of the touch device illustrated in FIG. 3A, taken along the AA′ direction, in accordance with some embodiments.

FIG. 4A is a schematic top view of a touch device in accordance with some embodiments.

FIG. 4B is a cross-sectional view of the touch device illustrated in FIG. 4A, taken along the BB′ direction, in accordance with some embodiments.

FIG. 5 is a flow diagram illustrating a method of manufacturing the touch device of FIG. 1A, in accordance with some embodiments.

FIG. 6 is a flow diagram illustrating a method of manufacturing the touch device of FIG. 3A, in accordance with some embodiments.

### DETAILED DESCRIPTION OF THE INVENTION

The embodiments are shown in the following description with the drawings, wherein similar or same components are indicated by similar reference numbers.

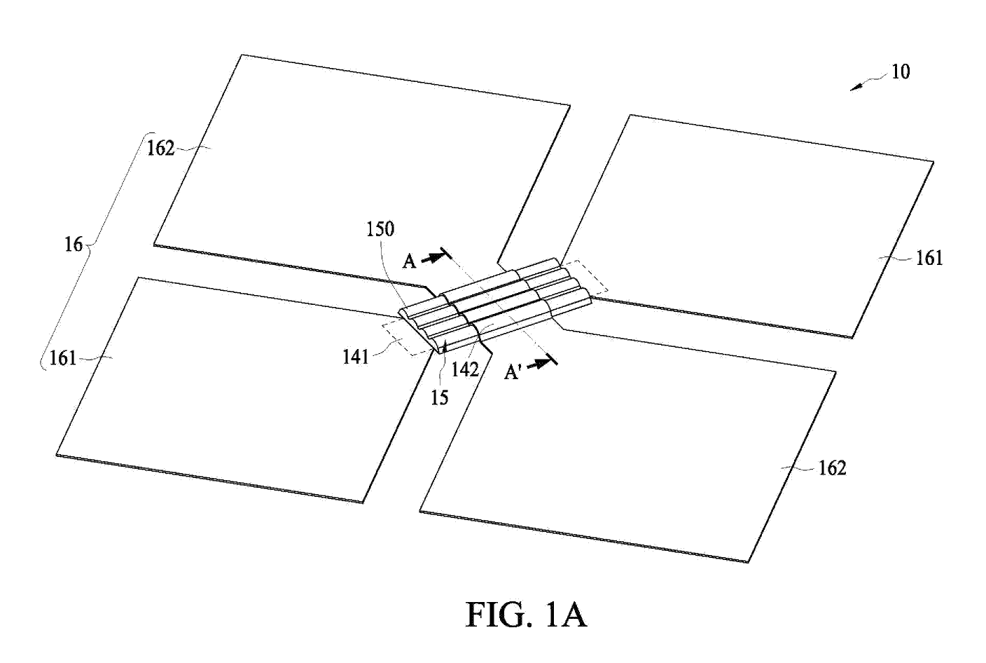

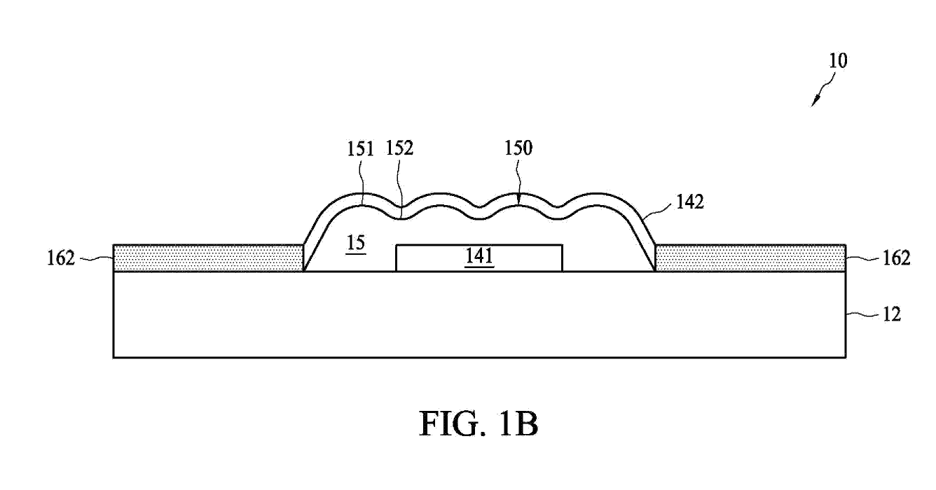

FIG. 1A is a schematic top view of a touch device 10 in accordance with some embodiments. Referring to FIG. 1A, the touch device 10 includes a sensor electrode layer 16, a first conductive jumper 141, a dielectric layer 15 and a second conductive jumper 142.

The sensor electrode layer 16, which is disposed on a substrate (not shown), is configured to detect a touch signal applied to the substrate and transmit a detected touch signal to a processor (not shown). In the present embodiment, the sensor electrode layer 16 includes first conductive sensors 161 arranged in a first direction, and second conductive sensors 162 arranged in a second (AA′) direction. The first conductive sensors 161 and the second conductive sensors 162 are electrically isolated from each other. The first conductive sensors 161 and the second conductive sensors 162 function to detect an applied touch signal, while the first conductive jumper 141 and the second conductive jumper 142 function to transmit a detected touch signal. Moreover, the first conductive jumper 141 is disposed on the substrate and electrically connects the first conductive sensors 161 in the first direction. The second conductive jumper 142 is disposed on the dielectric layer 15 and electrically connects the second conductive sensors 162 in the second direction. In some embodiments according to the present invention, the first conductive sensors 161 and the second conductive sensors 162 are arranged in a sensor array, in which the first conductive sensors 161 are arranged in rows in the first direction such as the X-axis direction, while the second conductive sensors 162 are arranged in columns in the second direction such as the Y-axis direction. The first direction is different from the second direction. In some embodiments, the first direction and the second direction intersect each other and are orthogonal to each other.

In some embodiments, the first and second conductive sensors 161 and 162 and the first and second conductive jumpers 141 and 142 include a transparent material selected from, but not limited to, indium tin oxide (ITO), indium zinc oxide (IZO), cadmium tin oxide (CTO), aluminum zinc oxide (AZO), indium tin zinc oxide (ITZO), zinc oxide, cadmium oxide, hafnium oxide (HfO), indium gallium zinc oxide (InGaZnO), indium gallium zinc magnesium oxide (InGaZnMgO), indium gallium magnesium oxide (InGaMgO) and indium gallium aluminum oxide (InGaAlO).

In some embodiments, suitable materials for the first and second conductive sensors 161 and 162 and the first and second conductive jumpers 141 and 142 include nanometals and metal meshes. Examples of the nanometals are nano silver wires, nano copper wires and carbon nanotubes. Furthermore, in some embodiments, the first and second conductive jumpers 141 and 142 are made of a non-transparent material such as metal.

The dielectric layer 15 is disposed on the first conductive jumper 141 and exposes portions of the first conductive jumper 141 so that the first conductive jumper 141 can electrically connect the first conductive sensors 161 in the first direction. Moreover, the dielectric layer 15 is disposed between the first conductive jumper 141 and the second conductive jumper 142 to electrically isolate the first conductive jumper 141 from the second conductive jumper 142, and hence electrically isolate the first conductive sensors 161 connected in the first direction by the first conductive jumper 141 from the second conductive sensors 162 connected in the second direction by the second jumper 142. In addition, the dielectric layer 15 has a patterned surface 150 that physically contacts the second conductive jumper 142 and embeds therein a portion of the second conductive jumper 142. As a result, the portion of the second conductive jumper 142 disposed on the dielectric layer 15 and embedded in the patterned surface 150 is less likely to be damaged by scratching. Even if the second conductive jumper 142 is incidentally scratched on an upper surface during a manufacturing process, the embedded portion of the second conductive jumper 142 can be kept unharmed and provide the desired connection function. Accordingly, the potential risk that the touch device 10 is damaged due to a scratch across the surface of the second conductive jumper 142, which may result in undesirably large resistance or open circuit, is reduced.

In some embodiments, the dielectric layer 15 includes a material selected from silicon oxide (SiO₂), silicon nitride (Si₃N₄) and photoresist, which includes positive photoresist and negative photoresist materials. An exemplary photoresist material is polyimide (PI). In some embodiments, the patterned surface 150 includes an undulating surface, which extends in the second direction (in terms of wave propagation). Further, the undulating surface has troughs, where the second conductive jumper 142 can be embedded. Moreover, in other embodiments, the patterned surface 150 includes a sawtooth-wave surface or an irregular surface. In still other embodiments, the patterned surface 150 includes a groove, which facilitates the second conductive jumper 142 to embed further into the patterned surface 150 so as to ensure a reliable electrical connection.

FIG. 1B is a cross-sectional view of the touch device illustrated in FIG. 1A, taken along an AA′ direction, in accordance with some embodiments. Referring to FIB. 1B, the sensor electrode layer 16 (see FIG. 1A), dielectric layer 15 and first conductive jumper 141 are disposed on a substrate 12. The substrate 12 is optically transmissive, and supports the sensor electrode layer 16 and dielectric layer 15 on a same surface thereof. In some embodiments, the substrate 12 includes a material selected from glass, polymethyl methacrylate (PMMA), polyvinyl chloride (PVC), polypropylene (PP), polyethylene terephthalate (PET), polyethylene naphthalate (PEN), polycarbonate (PC) and polystyrene (PS).

The patterned surface 150 of the dielectric layer 15 includes an undulating surface having crests 151 and troughs 152. When the second conductive jumper 142 is formed on the patterned surface 150, portions of the second conductive jumper 142 are embedded into the troughs 152. In some embodiments, the second conductive jumper 142 also has an undulating surface so that the second conductive jumper 142 has a substantially uniform thickness on the dielectric layer 15. Specifically, the thickness of the second conductive jumper 142 at the crests 151 of the patterned surface 150 is the same as that at the troughs 152 of the patterned surface 150. In other embodiments, however, the thickness of the second conductive jumper 142 at the crests 151 is different from that at the troughs 152. In still other embodiments, the upper surface of the second conductive jumper 142 takes other forms or shapes, or includes an irregular surface. In addition, in some embodiments, the shape of the undulating surface of the second conductive jumper 142 corresponds to the shape of the undulating surface of the dielectric layer 15.

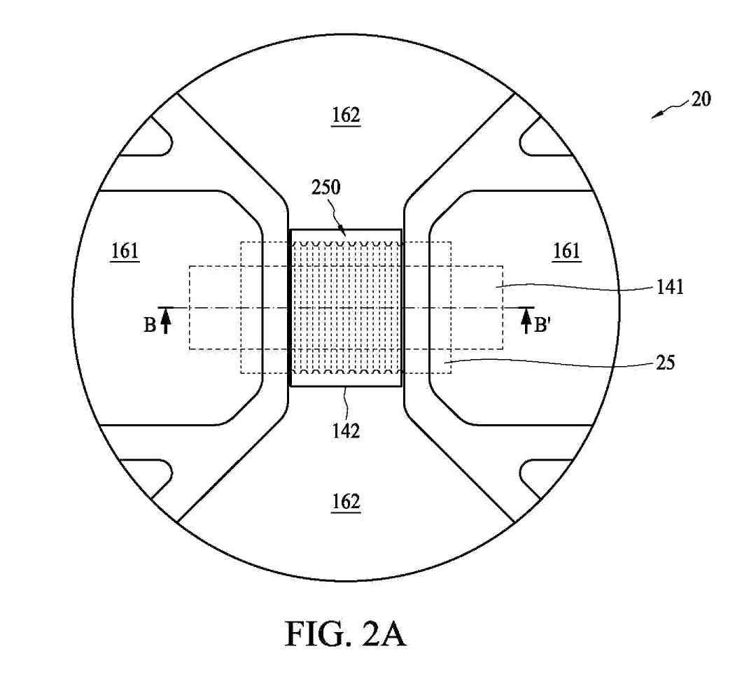

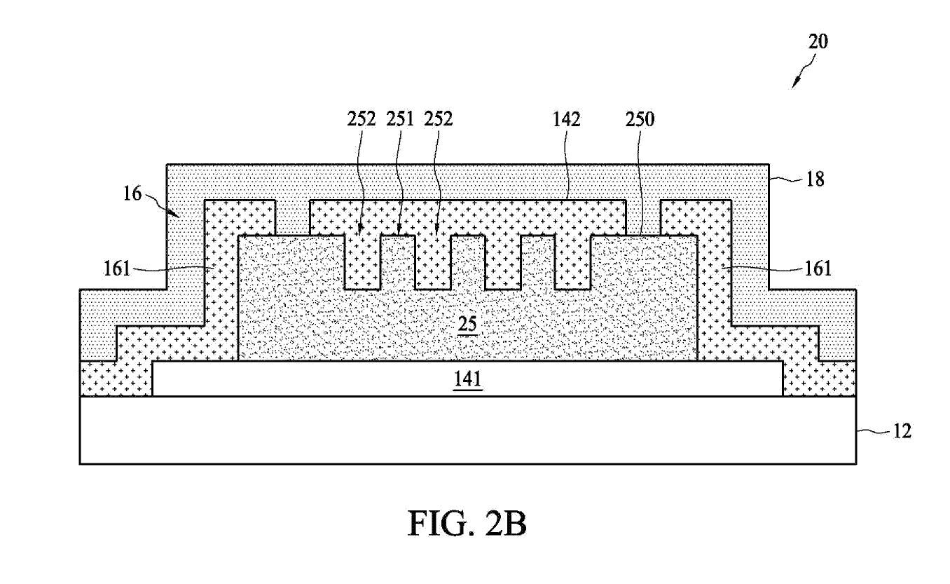

In addition, in some embodiments, also referring to FIG. 1A, the second conductive jumper 142 electrically connects the second conductive sensors 162 in the second direction (the AA′ direction). When a portion of the second conductive jumper 142 is damaged due to a scratch across its upper surface in the second direction, the other portions of the second conductive jumper 142 not affected by the scratch can still provide electrical connection between the second conductive sensors 162. However, the undulating, patterned surface 150 extends in the second direction (i.e., in the AA′ direction the undulating or wavy surface propagates), the same direction along which the second conductive sensors 162 are arranged. As a result, a scratch across the surface of the second conductive jumper 142 in the first direction may electrically disconnect the second conductive sensors 162. A solution to this issue can be found in a structure illustrated in FIGS. 2A and 2B, as will be discussed below.

FIG. 2A is a schematic top view of a touch device 20 in accordance with some embodiments. Referring to FIG. 2A, the touch device 20 is similar in function and structure to the touch device 10 described and illustrated with reference to FIG. 1A except that, for example, the touch device 20 includes a dielectric layer 25 different from the dielectric layer 15 of the touch device 10.

The dielectric layer 25 is disposed on the first conductive jumper 141 and exposes portions of the first conductive jumper 141 so that the first conductive jumper 141 can electrically connect the first conductive sensors 161 in the first direction. Moreover, the dielectric layer 25 is disposed between the first conductive jumper 141 and the second conductive jumper 142 to electrically isolate the first conductive jumper 141 from the second conductive jumper 142, and hence electrically isolate the first conductive sensors 161 connected in the first direction (the BB′ direction) by the first conductive jumper 141 from the second conductive sensors 162 connected in the second direction by the second jumper 142. In addition, the dielectric layer 25 has a patterned surface 250 that physically contacts the second conductive jumper 142 and embeds therein a portion of the second conductive jumper 142. As a result, the portion of the second conductive jumper 142 disposed on the dielectric layer 25 and embedded in the patterned surface 250 is less likely to be damaged by a scratch. Even if an upper surface of the second conductive jumper 142 is incidentally scratched during a manufacturing process, the embedded portion of the second conductive jumper 142 can be kept unharmed and provide the desired connection function. Accordingly, the potential risk that the touch device 20 is damaged due to a scratch across the surface of the second conductive jumper 142, which may result in undesirably large resistance or open circuit, is reduced.

FIG. 2B is a cross-sectional view of the touch device 20 illustrated in FIG. 2A, taken along a BB′ direction, in accordance with some embodiments. Referring to FIG. 2B and also to FIG. 2A, in some embodiments, the patterned surface 250 of the dielectric layer 25 includes a sawtooth-wave surface having crests 251 and troughs 252. When the second conductive jumper 142 is formed on the patterned surface 250, a portion of the second conductive jumper 142 is embedded in the troughs 252. The sawtooth-wave, patterned surface 250 extends substantially in the first direction (the BB′ direction), which intersects the second direction along which the second conductive sensors 162 are arranged.

When a portion of the second conductive jumper 142 is scratched on an upper surface in the second direction, the other portions of the second conductive jumper 142 not affected by the scratch can still provide electrical connection between the second conductive sensors 162. Moreover, when the second conductive jumper 142 is scratched on the surface in the first direction (the BB′ direction), the portion of the second conductive jumper 142 embedded in the troughs 252 can ensure electrical connection between the second conductive sensors 162. Effectively, the portion of the second conductive jumper 142 embedded in the troughs 252 protects the second conductive sensors 162 from electrical disconnection, no matter which direction the surface of the second conductive jumper 142 is scratched, and thus reduces the risk that the touch device 20 is damaged by a scratch.

In some embodiments, the second conductive jumper 142 has a substantially planar surface. As a result, the thickness of the second conductive jumper 142 at the crests 251 of the patterned surface 250 is smaller than that at the troughs 252 of the patterned surface 250. That is, the second conductive jumper 142 is not uniform in thickness on the dielectric layer 25. In some embodiments, however, the second conductive jumper 142 has a same thickness at the crests 251 and at the troughs 252 of the patterned surface 250. In still other embodiments, the immediately adjacent troughs 252 are spaced apart from each other by approximately 5 micrometers (um). Moreover, each trough 252 has a width of approximately 5 um in the first direction. In yet other embodiments, with the patterned surface 250, the contact area between the second conductive sensors 162 and the dielectric layer 25 is twice that versus not having such a patterned surface. The increased contact area facilitates protection of the second conductive jumper 142 from damage by scratching, and hence ensures electrical connection between the second conductive sensors 162.

The touch device 20 further includes a passivation layer 18, which entirely covers the substrate 12, dielectric layer 25 and sensor electrode layer 16. In some embodiments, the passivation layer 18 has a monolayer structure or a multilayer structure. In some embodiments, the passivation layer 18 includes a transparent material in a monolayer structure. Suitable materials for the passivation layer 18 include inorganic materials such as silicon oxide, silicon nitride and silicon oxynitride, and organic materials such as acrylic resin or the like, or a combination of the above-mentioned materials.

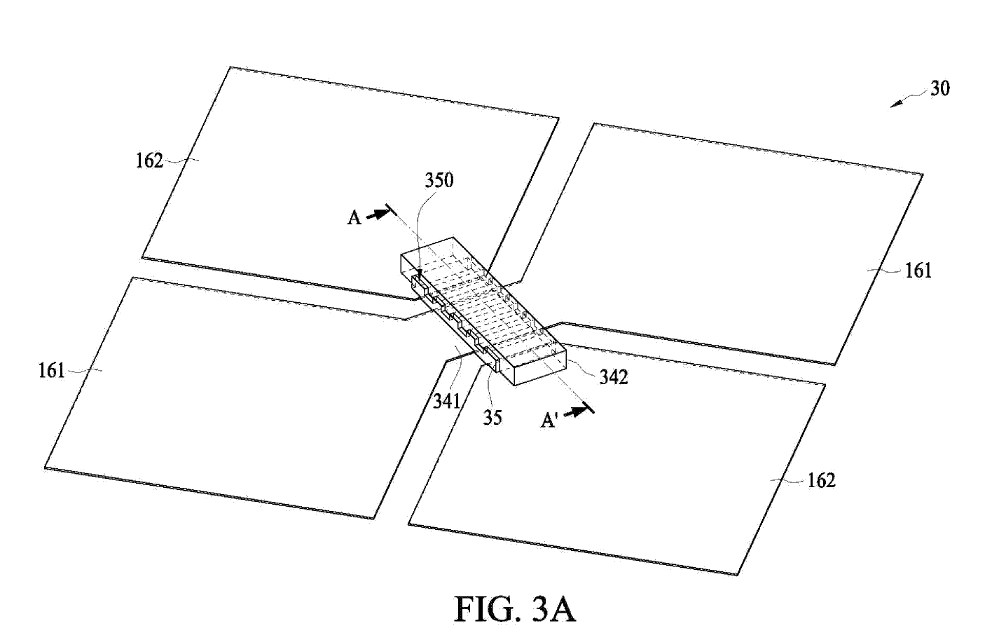

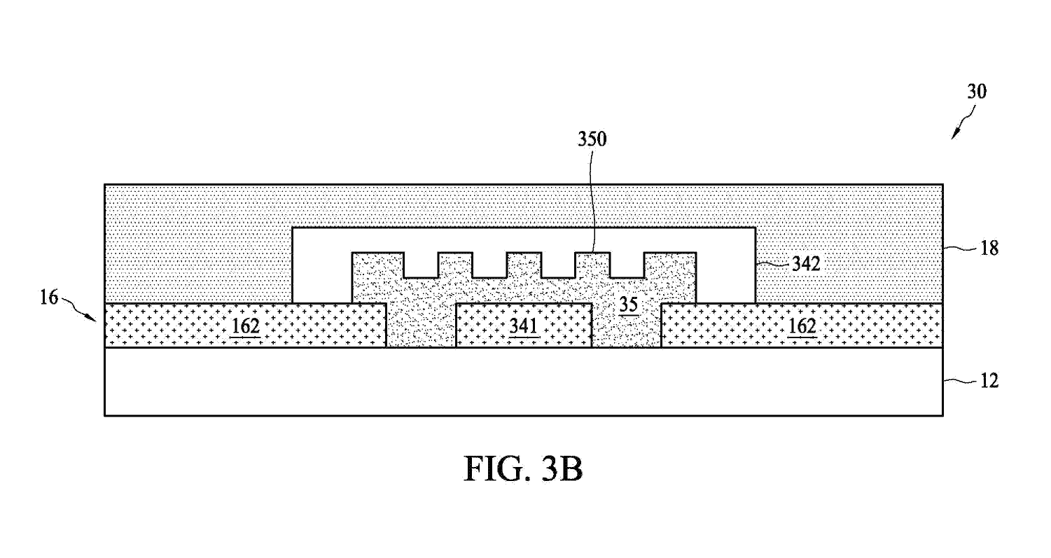

FIG. 3A is a schematic top view of a touch device 30 in accordance with some embodiments. Referring to FIG. 3A, the touch device 30 includes a first conductive jumper 341, a second conductive jumper 342 and a dielectric layer 35 having a patterned surface 350. Unlike in the touch device 10 described and illustrated with reference to FIG. 1A, where the first conductive jumper 141 is disposed on the substrate 12 and the patterned surface 150 of the dielectric layer 15 physically contacts the second conductive sensors 162, in the touch device 30, the first conductive sensors 161 arranged in the first direction and the second conductive sensors 162 arranged in the second direction (the AA′ direction) are disposed on the substrate 12, while the patterned surface 350 of the dielectric layer 35 physically contacts the second conductive jumper 342. The first conductive sensors 161 and the second conductive sensors 162 form a sensor array. In the sensor array, first conductive sensors 161 in a same row are electrically connected by the first conductive jumper 341, and second conductive sensors 162 in a same column are electrically by the second conductive jumper 342. Moreover, the first and second conductive jumpers 341 and 342 are electrically isolated from each other. Furthermore, the first conductive jumper 341 and the first conductive sensors 161 are integrally formed.

FIG. 3B is a cross-sectional view of the touch device 30 illustrated in FIG. 3A, taken along the AA′ direction, in accordance with some embodiments. Referring to FIG. 3B, a portion of the second conductive jumper 342 is embedded in the patterned surface 350. As a result, the portion of the second conductive jumper 342 embedded in the patterned surface 350 is less likely to be damaged by a scratch. Even if an upper surface of the second conductive jumper 342 is incidentally scratched during a manufacturing process, the embedded portion of the second conductive jumper 342 can still provide the desired connection function. Accordingly, the potential risk that the touch device 30 is damaged due to a scratch across the surface of the second conductive jumper 342, which may result in undesirably large resistance or open circuit, is reduced.

In some embodiments, suitable materials for the first and second conductive jumpers 341 and 342 are substantially the same as, or similar to, those for the first and second conductive jumpers 141 and 142. Moreover, in some embodiments, the patterned surface 350 of the dielectric layer 35 includes a sawtooth-wave surface having troughs, which are suitable for the embedding of the second conductive jumper 342. Furthermore, the sawtooth-wave, patterned surface 250 extends substantially in the second direction (the AA′ direction), the same direction along which the second conductive sensors 162 are arranged. In some embodiments, the patterned surface 350 includes an undulating surface or an irregular surface.

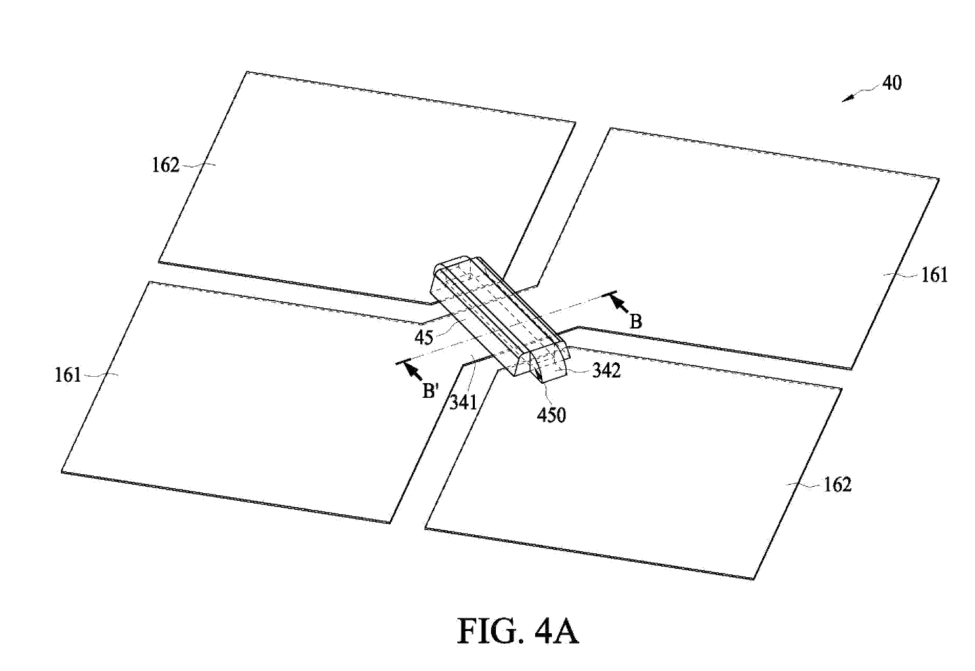

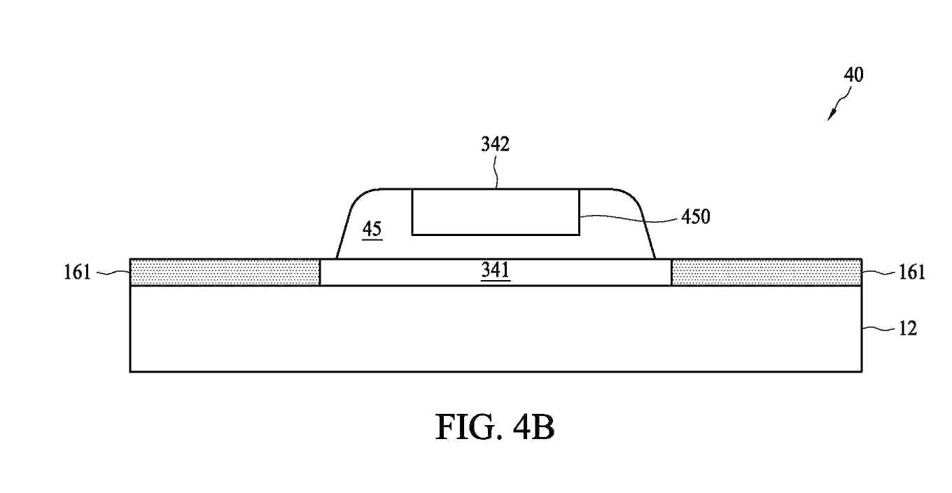

In addition, in some embodiments, also referring to FIG. 3A, the second conductive jumper 342 electrically connects the second conductive sensors 162 in the second direction (the AA′ direction). When a portion of the second conductive jumper 342 is damaged due to a scratch across its upper surface in the second direction, the other portions of the second conductive jumper 342 not affected by the scratch can still provide electrical connection between the second conductive sensors 162. The undulating, patterned surface 350 extends in the second direction (e.g., in the AA′ direction), the same direction along which the second conductive sensors 162 are arranged. As a result, a scratch across the surface of the second conductive jumper 342 in the first direction could possibly electrically disconnect the second conductive sensors 162. A solution to this issue is illustrated in FIGS. 4A and 4B, as will be discussed below.

FIG. 4A is a schematic top view of a touch device 40 in accordance with some embodiments. Referring to FIG. 4A, the touch device 40 is similar in function and structure to the touch device 30 described and illustrated with reference to FIG. 3A except that the touch device 40 at least includes a dielectric layer 45 different from the dielectric layer 35 of the touch device 30. As illustrated in FIGS. 4A and 4B, the patterned surface of the dielectric layer 45 includes a single groove 450. In other embodiments, however, multiple grooves may be defined in the patterned surface of the dielectric layer 45 to form an undulating surface or a sawtooth-wave surface.

In some embodiments, the patterned surface of the dielectric layer 45 extends in the first direction (the BB′ direction), which intersects the second direction along which the second conductive sensors 162 are arranged. Moreover, the second conductive jumper 342 embedded in the groove 450 extends in the second direction and electrically connects the second conductive sensors 162. The first conductive sensors 161 and the second conductive sensors 162 form a sensor array. In the sensor array, first conductive sensors 161 in a same row are electrically connected by the first conductive jumper 341, and second conductive sensors 162 in a same column are electrically by the second conductive jumper 342. Moreover, the first and second conductive jumpers 341 and 342 are electrically isolated from each other. Furthermore, the first conductive jumper 341 and the first conductive sensors 161 are integrally formed.

FIG. 4B is a cross-sectional view of the touch device 40 illustrated in FIG. 4A, taken along the BB′ direction, in accordance with some embodiments. Referring to FIG. 4B, in some embodiments, the second conductive jumper 342 is substantially entirely embedded in the groove 450, without limitation thereto. As a result, the second conductive jumper 342 disposed on the dielectric layer 45 and embedded in the groove 450 is less likely to be damaged by a scratch. Even if an upper surface of the second conductive jumper 342 is incidentally scratched during a manufacturing process, the embedded portion of the second conductive jumper 342 still provides the desired connection function. Accordingly, the potential risk that the touch device 40 is damaged due to a scratch across the surface of the second conductive jumper 342, which may result in undesirably large resistance or open circuit, is reduced.

In some embodiments, when a portion of the second conductive jumper 342 is scratched on an upper surface in the second direction, the other portions of the second conductive jumper 342 not affected by the scratch can still provide electrical connection between the second conductive sensors 162. Moreover, when the second conductive jumper 342 is scratched on the surface in the first direction (the BB′ direction), the portion of the second conductive jumper 342 embedded in the groove can ensure electrical connection between the second conductive sensors 162. Effectively, the portion of the second conductive jumper 342 embedded in the patterned surface of the dielectric layer 45 protects the second conductive sensors 162 from electrical disconnection, no matter which direction the surface of the second conductive jumper 342 is scratched, and thus reduces the risk that the touch device 40 is damaged from a scratch.

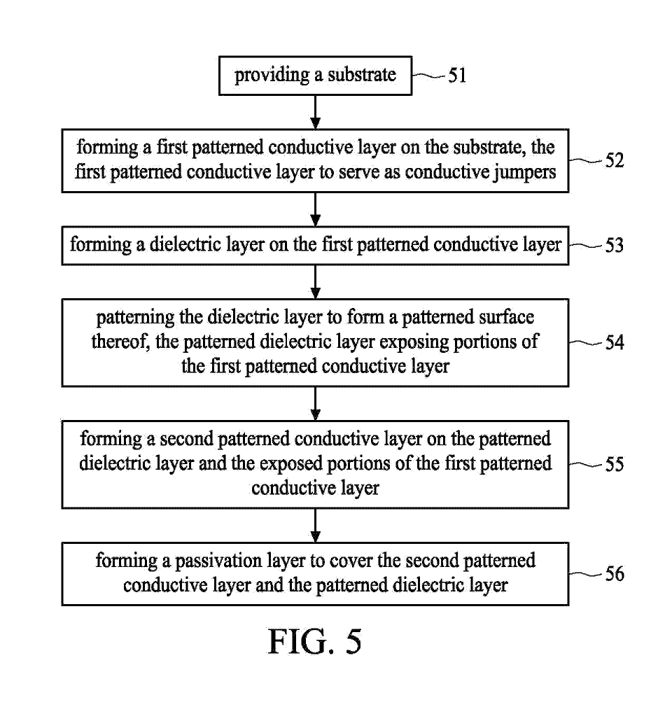

FIG. 5 is a flow diagram illustrating a method of manufacturing the touch device 10 of FIG. 1A, in accordance with some embodiments. Referring to FIG. 5 and also to FIG. 1A, in operation 51, a substrate is provided. In some embodiments, the substrate has undergone cleansing, strengthening and baking processes. In some embodiments, suitable materials for the substrate are selected from transparent materials, which include, but are not limited to, glass and polymethyl methacrylate (PMMA).

In operation 52, in some embodiments, a first patterned conductive layer is formed on the substrate by sputtering a first conductor on the substrate to form a first conductive layer, and then etching the first conductor layer. Suitable materials for the first conductor include, as previously discussed, transparent, nanometal and non-transparent materials. The first patterned conductive layer serves as a first conductive jumper, which electrically connects subsequently formed first conductive sensors arranged in the first direction.

In operation 53, in some embodiments, a dielectric layer is formed on the first patterned conductive layer by coating a dielectric material on the first patterned conductive layer, and soft-baking the dielectric material. The dielectric material is selected from silicon oxide (SiO₂), silicon nitride (Si₃N₄) and photoresist, which includes positive photoresist and negative photoresist materials. An exemplary photoresist material is polyimide (PI).

In operation 54, in some embodiments, a patterned dielectric layer is formed by etching the dielectric layer to form a patterned surface thereof and then removing unwanted portions. The patterned dielectric layer exposes portions of the first patterned conductive layer so that through the exposed portions the first patterned conductive layer is electrically connected to the first conductive sensors to be subsequently formed. In some embodiments, the patterned surface includes an undulating surface, a sawtooth-wave surface or a groove.

In operation 55, a second patterned conductive layer is formed on the patterned dielectric layer and the exposed portions of the first patterned conductive layer. In some embodiments, a second conductive layer is formed by sputtering a second conductor on the substrate, the patterned dielectric layer and the exposed portions of the first patterned conductive layer. The second conductive layer is then etched, resulting in the second patterned conductive layer. Suitable materials for the second conductor include, as previously discussed, transparent, nanometal and non-transparent materials. The second patterned conductive layer includes first conductive sensors arranged in a first direction, second conductive sensors arranged in a second direction and a second conductive jumper electrically connecting the second conductive sensors in the second direction. Moreover, the patterned surface of the patterned dielectric layer physically contacts the second conductive jumper and embeds therein a portion of the second conductive jumper.

In operation 56, a passivation layer is formed to cover the second patterned conductive layer and the patterned dielectric layer. In some embodiments, the passivation layer is formed by sputtering a transparent, insulating material on the substrate, the second patterned conductive layer and the patterned dielectric layer. Suitable materials for the passivation layer include, for example, silicon oxide, silicon nitride and silicon oxynitride.

The exemplary method illustrated in FIG. 5 is adapted to manufacture at least a touch device structure such as the touch device 10 illustrated in FIGS. 1A and 1B or the touch device 20 illustrated in FIGS. 2A and 2B. In the touch device structure, the first conductive jumper 141 is disposed below the dielectric layer 15, and the dielectric layer 15 is disposed between the first conductive jumper 141 and the second conductive jumper 142. Moreover, the patterned surface 150 of the dielectric layer 15 physically contacts the second conductive jumper 142.

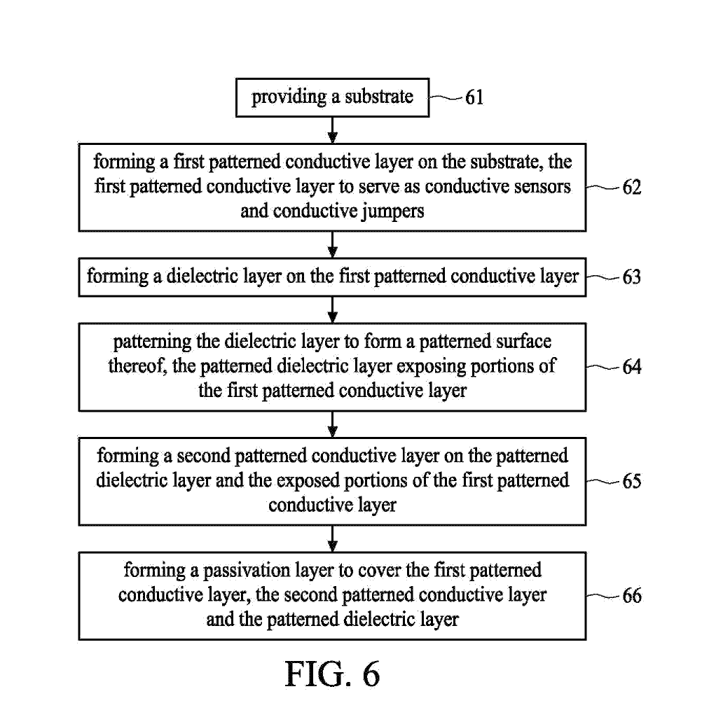

FIG. 6 is a flowchart illustrating a method of manufacturing at least the touch device 30 of FIG. 3A, in accordance with some embodiments. Referring FIG. 6 and also to FIG. 3A, in operation 61, a substrate is provided, which may be undergone a cleansing, strengthening and baking process. In some embodiments, suitable materials for the substrate are selected from transparent materials, which may include but are not limited to glass and polymethyl methacrylate (PMMA).

In operation 62, in some embodiments, a first patterned conductive layer is formed on the substrate by sputtering a first conductor on the substrate to form a first conductive layer, and then etching the first conductive layer. Suitable materials for the first conductor include, as previously discussed, transparent, nanometal and non-transparent materials. The first patterned conductive layer includes first conductive sensors arranged in a first direction, a first conductive jumper electrically connecting the first conductive sensors in the first direction, and second conductive sensors arranged in a second direction.

In operation 63, in some embodiments, a dielectric layer is formed on the first patterned conductive layer by coating a dielectric material on the first patterned conductive layer, and soft-baking the dielectric material. The dielectric material is selected from silicon oxide (SiO₂), silicon nitride (Si₃N₄) and photoresist, which includes positive photoresist and negative photoresist materials. An exemplary photoresist material is polyimide (PI).

In operation 64, in some embodiments, a patterned dielectric layer is formed by etching the dielectric layer to form a patterned surface thereof and then removing unwanted portions. The patterned dielectric layer exposes portions of the first patterned conductive layer so that, through the exposed portions, the first patterned conductive layer is electrically connected to a conductive jumper to be subsequently formed. In some embodiments, the patterned surface includes an undulating surface, a sawtooth-wave surface or a groove.

In operation 65, a second patterned conductive layer is formed on the patterned dielectric layer and a portion of the exposed portions of the first patterned conductive layer. In some embodiments, a second conductive layer is formed by sputtering a second conductor on the substrate, the patterned dielectric layer and the exposed portions of the first patterned conductive layer. The second conductive layer is then etched, resulting in the second patterned conductive layer. Suitable materials for the second conductor include, as previously discussed, transparent, nanometal and non-transparent materials. The second patterned conductive layer serves as a second conductive jumper, which electrically connects, in the second direction, the second conductive sensors formed in operation 62. Moreover, the patterned surface of the patterned dielectric layer physically contacts the second conductive jumper and embeds therein a portion of the second conductive jumper.

In operation 66, a passivation layer is formed to cover the first patterned conductive layer, the second patterned conductive layer and the patterned dielectric layer. In some embodiments, the passivation layer is formed by sputtering a transparent, insulating material on the substrate, the first patterned conductive layer, the second patterned conductive layer and the patterned dielectric layer. Suitable materials for the passivation layer include, for example, silicon oxide, silicon nitride and silicon oxynitride.

The exemplary method illustrated in FIG. 6 is adapted to manufacture at least a touch device structure such as the touch device 30 illustrated in FIGS. 3A and 3B or the touch device 40 illustrated in FIGS. 4A and 4B. In the touch device structure, the second conductive jumper 342 is disposed on the dielectric layer 35, and the dielectric layer 35 is disposed between the first conductive jumper 341 and the second conductive jumper 342. Moreover, the patterned surface 350 of the dielectric layer 35 physically contacts the second conductive jumper 342.

In embodiments according to the present disclosure, the patterned surface 150 of the dielectric layer 15 physically contacts a conductor and embeds therein a portion of the conductor. For example, in the touch device 10 described and illustrated with reference to FIG. 1A, the patterned surface 150 of the dielectric layer 15 physically contacts the second conductive jumper 142 and a portion of the second conductive jumper 142 is embedded in the patterned surface 150. Moreover, in the touch device 30 described and illustrated with reference to FIG. 3A, the patterned surface 350 of the dielectric layer 35 physically contacts the second conductive jumper 342 and a portion of the second conductive jumper 342 is embedded in the patterned surface 350. The embodiments according to the present disclosure are applicable to touch device structures in which a dielectric layer is in physical contact with a conductor and the embedded portion of the conductor on the dielectric layer is less likely to be damaged by a scratch. Even if an upper surface of the conductor is incidentally scratched during a manufacturing process, the embedded portion of the conductor can be kept unharmed and provide the desired connection function. Accordingly, the potential risks that the touch devices are damaged due to a scratch across the surface of the conductor, which may result in undesirably large resistance or open circuit, are reduced.

Embodiments according to the present disclosure provide a touch device. The touch device comprises a sensor electrode layer including conductive sensors, a conductive jumper configured to electrically connect the conductive sensors, and a dielectric layer having a patterned surface to physically contact the conductive jumper and embed therein a portion of the conductive jumper.

In some embodiments, the patterned surface includes an undulating surface.

In some embodiments, the conductive jumper includes an undulating surface.

In some embodiments, the patterned surface includes a crest and a trough, and the conductive jumper has a same thickness at the crest and at the trough.

In some embodiments, the patterned surface includes a crest and a trough, and the conductive jumper has a thickness at the crest smaller than that at the trough.

In some embodiments, the patterned surface includes a groove and the conductive jumper is embedded in the groove.

In some embodiments, the sensor electrode layer includes first conductive sensors arranged and electrically connected in a first direction, and second conductive sensors arranged and electrically connected in a second direction. Moreover, the conductive jumper includes a first conductive jumper and a second conductive jumper. The first conductive jumper electrically connects the first conductive sensors in the first direction, while the second conductive jumper electrically connects the second conductive sensors. Furthermore, the dielectric layer is disposed between the first conductive jumper and the second conductive jumper.

In some embodiments, the undulating surface extends along the second direction.

In some embodiments, the undulating surface extends perpendicularly to the second direction.

Some embodiments according to the present disclosure also provide a touch device. The touch device comprises a substrate, first conductive sensors arranged on the substrate in a first direction, second conductive sensors arranged on the substrate in a second direction, a first conductive jumper disposed on the substrate and electrically connecting the first conductive sensors in the first direction, a second conductive jumper connecting the second conductive sensors in the second direction, and a dielectric layer disposed between the first conductive jumper and the second conductive jumper and having a patterned surface, wherein the second conductive jumper physically contacts the patterned surface and a portion of the second conductive jumper is embedded in the patterned surface.

In some embodiments, the patterned surface includes an undulating surface.

In some embodiments, the undulating surface extends along the second direction.

In some embodiments, the undulating surface extends across the second direction.

In some embodiments, the patterned surface includes a crest and a trough, and the second conductive jumper has a same thickness at the crest and at the trough.

In some embodiments, the patterned surface includes a crest and a trough, and the second conductive jumper has a thickness at the crest smaller than that at the trough.

In some embodiments, the patterned surface includes a groove and the second conductive jumper is embedded in the groove.

In some embodiments, the first conductive jumper and the first conductive sensors are integrally formed.

Although the present disclosure and its advantages have been described in detail, it should be understood that various changes, substitutions and alterations can be made herein without departing from the spirit and scope defined by the appended claims. For example, many of the operations discussed above can be implemented in different methodologies and replaced by other operations, or a combination thereof.

Moreover, the scope of the present application is not intended to be limited to the particular embodiments of the process, machine, methods and steps described in the specification. As one of ordinary skill in the art will readily appreciate from the disclosure, processes, machines, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, methods, or steps.

What is claimed is:

1. A touch device, comprising:
a sensor electrode layer including conductive sensors;
a conductive jumper configured to electrically connect the conductive sensors; and
a dielectric layer having a patterned surface to physically contact the conductive jumper and embed therein a portion of the conductive jumper.

2. The touch device of claim 1, wherein the patterned surface includes a first undulating surface.

3. The touch device of claim 2, wherein the conductive jumper has a second undulating surface corresponding to the first undulating surface.

4. The touch device of claim 2, wherein the patterned surface includes a crest and a trough, and the conductive jumper has a same thickness at the crest and at the trough.

5. The touch device of claim 2, wherein the patterned surface includes a crest and a trough, and the conductive jumper has a thickness at the crest smaller than that at the trough.

6. The touch device of claim 1, wherein the patterned surface includes a groove and the conductive jumper is embedded in the groove.

7. The touch device of claim 2, wherein the sensor electrode layer includes first conductive sensors arranged and electrically connected in a first direction, and second conductive sensors arranged and electrically connected in a second direction, and wherein the conductive jumper includes a first conductive jumper and a second conductive jumper, wherein the first conductive jumper electrically connects the first conductive sensors in the first direction, the second conductive jumper electrically connects the second conductive sensors, and the dielectric layer is disposed between the first conductive jumper and the second conductive jumper.

8. The touch device of claim 7, wherein the first undulating surface extends along the second direction.

9. The touch device of claim 7, wherein the first undulating surface extends perpendicularly to the second direction.

10. A touch device, comprising:
a substrate;
first conductive sensors arranged on the substrate in a first direction;
second conductive sensors arranged on the substrate in a second direction;
a first conductive jumper disposed on the substrate and electrically connecting the first conductive sensors in the first direction;
a second conductive jumper connecting the second conductive sensors in the second direction; and
a dielectric layer disposed between the first conductive jumper and the second conductive jumper and having a patterned surface, wherein the second conductive jumper physically contacts the patterned surface and a portion of the second conductive jumper is embedded in the portion of the dielectric layer having the patterned surface.

11. The touch device of claim 10, wherein the patterned surface includes a first undulating surface.

12. The touch device of claim 11, wherein the first undulating surface extends along the second direction.

13. The touch device of claim 11, wherein the first undulating surface extends perpendicularly to the second direction.

14. The touch device of claim 11, wherein the patterned surface includes a crest and a trough, and the second conductive jumper has a same thickness at the crest and at the trough.

15. The touch device of claim 11, wherein the patterned surface includes a crest and a trough, and the second conductive jumper has a thickness at the crest smaller than that at the trough.

16. The touch device of claim 10, wherein the patterned surface includes a groove and the second conductive jumper is embedded in the groove.

17. The touch device of claim 16, wherein the first conductive jumper and the first conductive sensors are integrally formed.
